(19) United States
(12) Patent Application Publication
(10) Pub. No.: US 2025/0070283 A1
(43) Pub. Date: Feb. 27, 2025

(54) AUTOMOTIVE BATTERY ASSEMBLIES

(71) Applicants: Robert Busich, Cottonwood, AZ (US); Jaime John Burns Dugan, Franklin, NC (US)

(72) Inventors: Robert Busich, Cottonwood, AZ (US); Jaime John Burns Dugan, Franklin, NC (US)

(21) Appl. No.: 18/813,357

(22) Filed: Aug. 23, 2024

Related U.S. Application Data
(60) Provisional application No. 63/578,480, filed on Aug. 24, 2023.

(51) Int. Cl. H01M 10/42; H01M 50/249; H01M 50/267; H01M 50/507

(52) U.S. Cl. CPC H01M 10/4264; H01M 50/249; H01M 50/267; H01M 50/507

(57) ABSTRACT

An automotive battery assembly includes an automotive battery and a supercapacitor each connected to a positive terminal and a negative terminal and a booster battery connected to the positive terminal and the negative terminal through a switch having an open position, disconnecting the booster battery from the positive terminal and the negative terminal, and a closed position, connecting the booster battery to the positive terminal and the negative terminal to provide a burst of power through the positive terminal and the negative terminal from the booster battery. In one embodiment, the switch is part of a control system to monitor the automotive battery and the supercapacitor and turn the switch from the open position to the closed position automatically when the automotive battery and the supercapacitor are low or significantly discharged. In another embodiment, the switch is a toggle switch that is operated manually.

### CROSS-REFERENCE TO RELATED APPLICATION

This application claims the benefit of U.S. Provisional Patent Application No. 63/578,480, filed Aug. 24, 2023, incorporated herein by reference for all purposes.

### FIELD OF THE INVENTION

The present invention relates to batteries and, more particularly, automotive batteries.

### DESCRIPTION OF RELATED ART

An automotive or car battery is rechargeable and used to start a motor vehicle. It supplies an electric current to the vehicle's starter motor configured to activate the internal combustion engine. Once the engine runs, the battery continues to supply power for the vehicle's electrical systems while the alternator charges the battery as capacity demands increase or decrease.

Automotive batteries have limited life spans, which vary depending on weather conditions, time, corrosion, electronic drain, parasitic drain, etc. Unfortunately, motorists often suffer a battery of insufficient charge to start their vehicle, usually an occasion of inconvenience and distress when one cannot booster-start the vehicle. Despite current advancements in automotive batteries, there is a need for an automotive battery configured to limit battery drain and with surplus and booster engine start functionalities and that is easy to maintain and network-, Wi-Fi-, and Bluetooth-enabled to effectuate the exchange of information with networked and mobile devices.

### SUMMARY OF THE INVENTION

According to the invention, an automotive battery assembly includes a control system including a switch having an open position and a closed position, an automotive battery connected to a positive terminal and a negative terminal, and a booster battery connected to the positive terminal and the negative terminal through the switch in the open position, disconnecting the booster battery from the positive terminal and the negative terminal, the control system to monitor the automotive battery and turn the switch from the open position to the closed position automatically when the automotive battery is low or significantly discharged, connecting the booster battery to the positive terminal and the negative terminal to provide a burst of power through the positive terminal and the negative terminal. The automotive battery and the booster battery are separately replaceable. The automotive battery is connected to the positive terminal and the negative terminal through a positive bus bar and a negative bus bar, respectively. The booster battery is connected to the positive bus bar and the negative bus bar, respectively, connected to the positive terminal and the negative terminal, respectively, through the switch. The control system, the automotive battery, the positive terminal, the negative terminal, the booster battery, the positive bus bar and the negative bus bar are held by a housing, the positive terminal and the negative terminal extending outward from the housing.

According to the invention, an automotive battery assembly includes a control system including a switch having an open position and a closed position, an automotive battery and a supercapacitor each connected to a positive terminal and a negative terminal, and a booster battery connected to the positive terminal and the negative terminal through the switch in the open position, disconnecting the booster battery from the positive terminal and the negative terminal, the control system to monitor the automotive battery and the supercapacitor and turn the switch from the open position to the closed position automatically when the automotive battery and the supercapacitor are low or significantly discharged, connecting the booster battery to the positive terminal and the negative terminal to provide a burst of power through the positive terminal and the negative terminal. The automotive battery, the supercapacitor and the booster battery are separately replaceable. The automotive battery and the supercapacitor are connected to the positive terminal and the negative terminal through a positive bus bar and a negative bus bar, respectively. The booster battery is connected to the positive bus bar and the negative bus bar, respectively, connected to the positive terminal and the negative terminal, respectively, through the switch. The control system, the automotive battery, the supercapacitor, the positive terminal, the negative terminal, the booster battery, the positive bus bar and the negative bus bar are held by a housing, the positive terminal and the negative terminal extending outward from the housing.

According to the invention, an automotive battery assembly includes an automotive battery connected to a positive terminal and a negative terminal, and a booster battery connected to the positive terminal and the negative terminal through a toggle switch having an open position, disconnecting the booster battery from the positive terminal and the negative terminal, and a closed position, connecting the booster battery to the positive terminal and the negative terminal to provide a burst of power through the positive terminal and the negative terminal. The automotive battery and the booster battery are separately replaceable. The automotive battery is connected to the positive terminal and the negative terminal through a positive bus bar and a negative bus bar, respectively. The booster battery is connected to the positive bus bar and the negative bus bar, respectively, connected to the positive terminal and the negative terminal, respectively, through the switch. The automotive battery, the positive terminal, the negative terminal, the booster battery, the toggle switch, the positive bus bar and the negative bus bar are held by a housing, the positive terminal and the negative terminal extending outward from the housing and the toggle switch accessible from outside the housing.

According to the invention, an automotive battery assembly includes an automotive battery and a supercapacitor each connected to a positive terminal and a negative terminal, and a booster battery connected to the positive terminal and the negative terminal through a toggle switch having an open position, disconnecting the booster battery from the positive terminal and the negative terminal, and a closed position, connecting the booster battery to the positive terminal and the negative terminal to provide a burst of power through the positive terminal and the negative terminal. The automotive battery, the supercapacitor and the booster battery are separately replaceable. The automotive battery and the supercapacitor are connected to the positive terminal and the negative terminal through a positive bus bar and a negative bus bar, respectively. The booster battery is connected to the positive bus bar and the negative bus bar, respectively, connected to the positive terminal and the negative terminal, respectively, through the switch. The automotive battery, the supercapacitor, the positive terminal, the negative terminal, the booster battery, the toggle switch, the positive bus bar and the negative bus bar are held by a housing, the positive terminal and the negative terminal extending outward from the housing and the toggle switch accessible from outside the housing.

### BRIEF DESCRIPTION OF THE DRAWINGS

Specific objects and advantages of the invention will become readily apparent to those skilled in the art from the following detailed description of illustrative embodiments thereof, taken in conjunction with the drawings in which:

FIG. 1 is a diagrammatic illustration of an automotive battery assembly constructed and arranged according to the invention;

FIG. 2 is a top plan view corresponding to FIG. 1, illustrating power modules in a container;

FIG. 3 is a perspective view corresponding to FIG. 2, illustrating the container closed by a lid;

FIG. 4 is a view corresponding to FIG. 3, the lid depicted in phantom outline for illustrative purposes;

FIG. 5 is a block diagram of the automotive battery assembly of FIG. 1;

FIG. 6 is a diagrammatic illustration of an automotive battery assembly constructed and arranged according to the invention;

FIG. 7 is a diagrammatic illustration corresponding to FIG. 6, illustrating a lid in an open position, opening a container, part of the container shown in phantom outline for illustrative purposes;

FIG. 8 is a diagrammatic top plan view corresponding to FIGS. 6 and 7, illustrating the lid in the open position and power modules in the container;

FIG. 9 is a section view taken along line 9-9 of FIG. 8;

FIG. 10 is a section view taken along line 10-10 of FIG. 8;

FIG. 11 is a perspective view corresponding to FIG. 8, illustrating the container closed by the lid;

FIG. 12 is a view corresponding to FIG. 11, the lid depicted in phantom outline for illustrative purposes;

FIG. 13 is a fragmentary top plan view of the lid of FIG. 11, illustrating a switch in an open position; and

FIG. 14 is a view like FIG. 13, illustrating the switch in a closed position.

### DETAILED DESCRIPTION

### I.

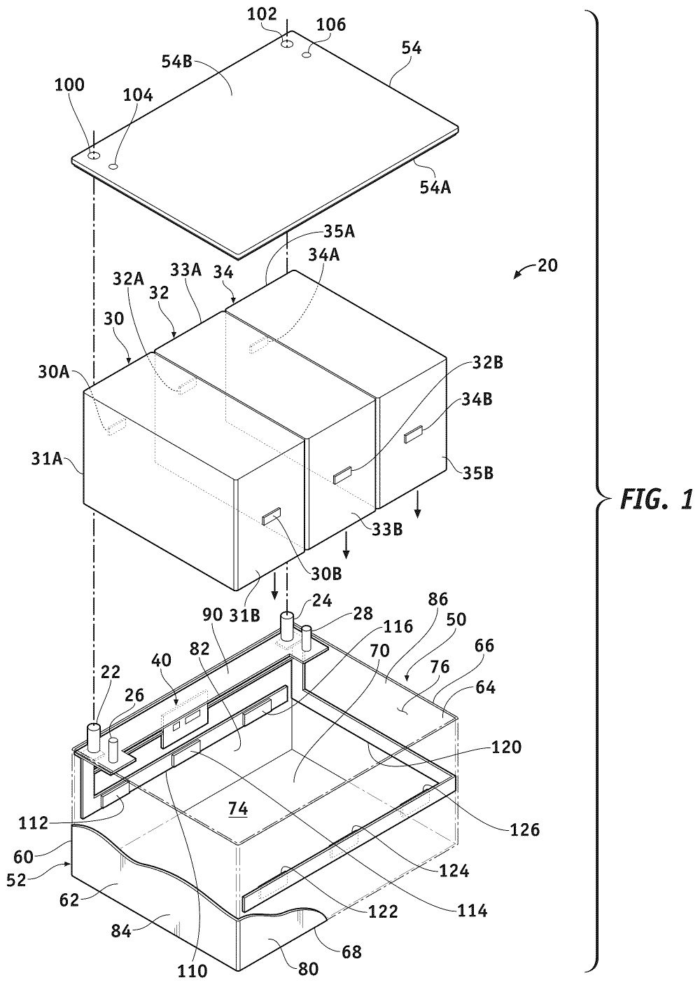

Referring to FIGS. 1-5 relevantly, an automotive or car battery assembly 20 includes a positive terminal 22, a negative terminal 24, a positive accessory terminal 26, a negative accessory terminal 28, power modules 30, 32, and 34, a control system 40, a positive bus bar 110, a negative bus bar 120 and, in FIG. 1, a housing 50 therefor. The positive terminal 22 and the positive accessory terminal 26 electrically connect to the positive bus bar 110. The negative terminal 24 and the negative accessory terminal 28 electrically connect to the negative bus bar 120. The positive bus bar 110 and the negative bus bar 120 connect electrically to the terminals 22, 24, 26, and 28 via standard electrical wiring, conductors, or other methods. The positive terminal 22 and the negative terminal 24 are standard automotive battery terminals that connect electrically to a circuit of a motor vehicle according to standard methods. Typically, the connectors of the motor vehicle's positive and negative battery cables connect to positive terminal 22 and the negative terminal 24, respectively, connecting the positive terminal 22 and the negative terminal 24 to the circuit. The positive and negative accessory terminals 26 and 28 connect by standard wiring methods to an accessory circuit of an accessory, such as a light bar, a winch, a spotlight, or other accessory of the motor vehicle. The power modules 30, 32, and 34 are self-contained and electrically connect to the positive bus bar 110 and the negative bus bar 120. They are independent power units that electrically connect to the positive bus bar 110 and the negative bus bar 120 independently from one another. The positive bus bar 110 and the negative bus bar 120 are each sets of standard electric conductors that form standard transmission paths or pathways between power the power module 30 and the terminals 22, 24, 26, and 28, the power module 32 and the terminals 22 and 24, and the power module 34 and the terminals 22 and 24.

The power module 30 connects electrically through the positive bus bar 110 and the negative bus bar 120 to the positive terminal 22, the negative terminal 24, the positive accessory terminal 26 and the negative accessory terminal 28 when the power module 30 is electrically connected to the positive bus bar 110 and the negative bus bar 120. The power module 30 provides power through the positive terminal 22, the negative terminal 24, the positive accessory terminal 26 and the negative accessory terminal 28, to supply a current to the motor vehicle circuit connected to the positive terminal 22 and the negative terminal 24, and a current to the accessory circuit connected to the positive accessory terminal 26 and the negative accessory terminal 28 when the power module 30 is electrically connected to the positive bus bar 110 and the negative bus bar 120.

The power module 32 connects electrically through the positive bus bar 110 and the negative bus bar 120 to the positive terminal 22 and the negative terminal 24 when the power module 32 is electrically connected to the positive bus bar 110 and the negative bus bar 120. The power module 32 is a surplus power module. It provides surplus power in the form of rapid charge/discharge current cycles through the positive terminal 22 and the negative terminal 24 during the motor vehicle start cycle when the power module 32 is electrically connected to the positive bus bar 110 and the negative bus bar 120, which reduces or otherwise relieves the power drain on the power module 30 during the start cycle for prolonging the useful life of the power module 30.

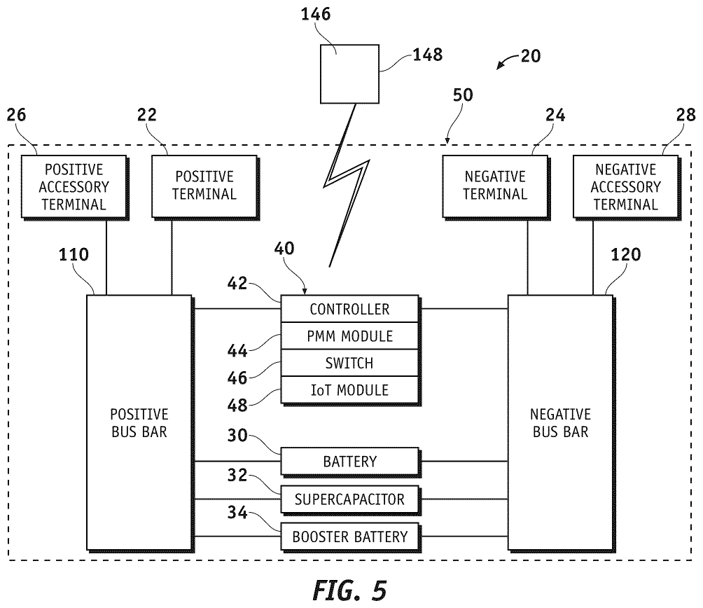

The power module 34 connects electrically to the positive bus bar 110 and the negative bus bar 120 that connect the power module 34 electrically through a switch 46 (FIG. 5) to the positive terminal 22 and the negative terminal 24 when the power module 34 is electrically connected to the positive bus bar 110 and the negative bus bar 120. When the power module 34 is electrically connected to the positive bus bar 110 and the negative bus bar 120, the power module 34 is disconnected from the positive terminal 22 and the negative terminal 24 when the switch 46 is in the open position and connected to the positive terminal 22 and the negative terminal 24 when the switch 46 is in the closed position. The power module 34 provides booster- or jump-start power through the positive terminal 22 and the negative terminal 24 to supply a current to the circuit of the motor vehicle connected to the positive and negative terminals 22 and 24 during motor vehicle start when the power module 34 is electrically connected to the positive bus bar 110 and the negative bus bar 120 and the switch 46 is in the closed position, such as when either or both of the power modules 30 and 32 are low or significantly discharged.

The power module 30 has opposed positive and negative electrical contacts 30A and 30B at its opposite ends 31A and 31B, respectively. The contacts 30A and 30B electrically connect to the positive bus bar 110 and the negative bus bar 120, respectively. The power module 30 provides extended capacitance. It is a battery of the standard automotive type. It has a standard power profile, and is rechargeable, and self-contained. Its purpose is to provide an electric current through the positive and negative terminals 22 and 24 to the motor vehicle circuit connected to the positive terminal 22 and the negative terminal 24 to actuate the starter motor to start the chemically powered internal combustion engine that propels the vehicle when the contacts 30A and 30B are electrically connected to the positive bus bar 110 and the negative bus bar 120, respectively. It also provides an electric current through the positive accessor terminal 26 and the negative accessory terminal 28 to the accessory circuit connected to the positive accessory terminal 26 and the negative accessory terminal 28 to actuate the accessory when the contacts 30A and 30B are electrically connected to the positive bus bar 110 and the negative bus bar 120, respectively. Once the engine is running, power for the vehicle's electrical systems is supplied by the power module 30 through the positive terminal 22, the negative terminal 24, the positive accessory terminal 26, and the negative accessory terminal 28, with the alternator charging the power module 30 as demands increase or decrease. Preferably, the power module 30 is a lithium-ion battery, a lead-acid battery, or other suitable automotive battery. When the power module 30 is low or significantly discharged, it is insufficiently charged to actuate the starter motor to start the engine.

The power module 32 has opposed positive and negative electrical contacts 32A and 32B at its opposite ends 33A and 33B, respectively. The contacts 32A and 32B electrically connect to the positive bus bar 110 and the negative bus bar 120, respectively. The power module 32 provides rapid charge/discharge cycles. The power module 32 is not a battery. It is a supercapacitor. It has a standard power profile, and is rechargeable, and self-contained. Its purpose is to provide rapid charge/discharge current cycles through the positive terminal 22 and the negative terminal 24 to the motor vehicle circuit connected to the positive terminal 22 and the negative terminal 24 during the start cycle to actuate the starter motor to start the chemically-powered internal combustion engine that propels the vehicle when the contacts 32A and 32B are electrically connected to the positive bus bar 110 and the negative bus bar 120, respectively, reducing or otherwise relieving the power drain on the power module 30 during the start cycle for prolonging the useful life of the power module 30. The supercapacitor power module 32 provides rapid charge/discharge cycles due to its inherently high power density and inherently low internal resistance, stores more energy per unit volume or mass than electrolytic capacitors, can accept and deliver charge much faster than standard batteries, and tolerates many more charge and discharge cycles than rechargeable batteries, such as the power module 30. Once the engine is running, the alternator charges the power module 32 while the power module 30 provides power for the vehicle's electrical systems through the positive terminal 22, the negative terminal 24, the positive accessory terminal 26, and the negative accessory terminal 28. The power module 32 inherently charges faster than the power module 30. When the power module 32 is low or significantly discharged, it is insufficiently charged to actuate the starter motor to start the engine.

The power module 34 has opposed positive and negative electrical contacts 34A and 34B at its opposite ends 35A and 35B. The contacts 34A and 34B electrically connect to the positive bus bar 110 and the negative bus bar 120, respectively. The power module 34 is a standard booster battery, often referred to as a jump starter or battery booster, that provides a burst of power. It has a standard power profile, and is rechargeable, and self-contained. Its purpose is to provide a burst of electric current through the positive and negative terminals 22 and 24 to the motor vehicle circuit connected to the positive terminal 22 and the negative terminal 24 sufficient to actuate the starter motor to jump-start the chemically-powered internal combustion engine that propels the vehicle when the power module 30 is low or significantly discharged or when both power modules 30 and 32 are low or significantly discharged and when the contacts 34A and 34B are electrically connected to the positive bus bar 110 and the negative bus bar 120, respectively. By delivering a burst of power, the power module 34 provides the sufficient energy to start the engine when the power module 30 is low of significantly discharged or when the power modules 30 and 32 are low or significantly discharged. Once the engine is running, the alternator charges the power module 34 while the power module 30 provides whatever power it can for the vehicle's electrical systems through the positive terminal 22, the negative terminal 24, the positive accessory terminal 26, and the negative accessory terminal 28.

According to its standard power profile, the power module 30 suitably charged measures around 12.6 volts, with a normal voltage range of 12.4 to 12.8 volts. This power actuates the motor vehicle's starter motor through the circuit connected to the positive and negative terminals 22 and 24 to start the engine during the start cycle. Generally, the power level of a standard vehicle battery, like the power module 30, is normal when it is in the normal range and low or significantly discharged when it is below the normal range. When the power module 30 is low or significantly discharged, the power module 30 still has a charge, enough to power the controller 40 and perhaps the accessory connected to the positive and negative accessory terminals 26 and 28. Still, it may not be sufficiently charged to actuate the motor vehicle's starter through the circuit connected to the positive and negative terminals 22 and 24 to start the engine during the start cycle. When the power module 30 is low or significantly discharged, it may need servicing or replacement. The power modules 32 and 34 have the same power profile as the power module 30.

The control system 40 is electrically connected between the positive bus bar 110 and the negative bus bar 120 via standard electrical wiring, conductors, or other methods. The control system 40 couples in electrical, signal, and data communication through the positive bus bar 110 and the negative bus bar 120 to the power modules 30, 32, and 34 when they are electrically connected to the positive bus bar 110 and the negative bus bar 120. The control system 40 is powered constantly by the power module 30 when the power module 30 is electrically connected to the positive bus bar 110 and the negative bus bar 120.

The control system 40 includes a controller 42, a power management module (PMM) 44, a switch 46, and an Internet-of-things (“IoT”) module 48, all connected in electrical, signal, and data communication according to known methods. The controller 42 and the PMM module 38 are programmable. The controller 42, one or more programmable logic controllers or processors, controls the operation of switch 46. The PMM module 44 is a standard, programmable system architecture that continually monitors the power levels, temperatures and other parameters of the power modules 30, 32, and 34 to provide detailed information about the states of charge and health of the power modules 30, 32, and 34, and issues signals to the controller 42 when the power modules 30, 32, and 34 are electrically connected to the positive bus bar 110 and the negative bus bar 120. The IoT module 48 is a standard device with sensors, processing ability, software and other technologies that network enables the battery assembly 20, allowing it to connect and exchange data with other devices and systems over the Internet or other communications networks, including a wired or wireless network of a vehicle. The IoT module 48 is Wi-Fi-, and Bluetooth-enabled to effectuate the exchange of information with networked and mobile devices.

The switch 46 works between the power module 34 and the positive terminal 22 and the negative terminal 24 when the power module 34 is electrically connected to the positive bus bar 110 and the negative bus bar 120. The switch 46 is a standard electronic switch having an open position, disconnecting the power module 34 from the positive terminal 22 and the negative terminal 24 when the power module 34 is electrically connected to the positive bus bar 110 and the negative bus bar 120, and a closed position, connecting the power module 34 through the positive bus bar 110 and the negative bus bar 120 to the positive terminal 22 and the negative terminal 24 when the power module 34 is electrically connected to the positive bus bar 110 and the negative bus bar 120. The power module 34 electrically connects to the positive bus bar 110 and the negative bus bar 120 electrically connected to the positive terminal 22 and the negative terminal 24, respectively, through the switch 46.

The PMM module 44 operates according to its programming. In one mode of operation, the PMM module 44 is programmed to the power module 30 when the power module 30 is electrically connected to the positive bus bar 110 and the negative bus bar 120 and issue a signal to the controller 42 when the power module 30 is low or significantly discharged, and the controller 42 is programmed to turn the switch 46 from its normal open position automatically, disconnecting the power module 34 from each of the positive terminal 22 and the negative terminal 24, to the closed position, connecting the power module 34 to each of the positive terminal 22 and the negative terminal 24 when the processor 42 receives the signal. In another mode of operation, the PMM module 44 is programmed to monitor the power module 30 and the power module 32 when the power modules 30 and 32 are electrically connected to the positive bus bar 110 and the negative bus bar 120 and issue the signal to the controller 42 when the power module 30 and the power module 32 are low or significantly discharged, and the controller 42 is programmed to turn the switch 46 from its normal open position automatically, disconnecting the power module 34 from each of the positive terminal 22 and the negative terminal 24, to the closed position, connecting the power module 34 to each of the positive terminal 22 and the negative terminal 24 when the processor 42 receives the signal.

The housing 50 is proportional in size to a standard automotive battery. Referring to FIGS. 1-4 relevantly, the housing 50 supports the battery assembly 20 components described above. The housing is of plastic, hard rubber, or other inherently strong, rugged, resilient, electrically non-conductive, heat-resistant, chemical-resistant, and fluid-impervious material or combination of materials. The housing 50 includes a container 52 and a lid 54 having an inner surface 54A and an outer surface 54B. The container 50 includes a sidewall 60 extending upright from a bottom 70. The sidewall 60 is continuous and has an outer surface 62, an inner surface 64, an upper edge or rim 66, and a lower edge 68. The bottom 70 affixed to the lower edge 68 defines the housing's 50 closed bottom. The sidewall 60 extends between the lower edge 68 affixed to the bottom 70 and the rim 66 at the opposed open end of the container 52, closable by the lid 54. The bottom 70 cooperates with the inner surface 64 to form a fluid-impervious volume 74. The rim 66 is continuous and encircles an opening 76 to the volume 74 to receive batteries 30, 32, and 34 placed therein and onto the bottom 70 through the opening 74 directly over the bottom 70.

The sidewall 60 includes opposite parallel side walls 80 and 82 that extend between opposite parallel end walls 84 and 86. The side walls 80 and 82 at the opposite sides of the container 52 are equal in length and longer than equal-length end walls 84 and 86 at the opposite ends of the container 52. The housing 52 is rectangular, in which the side walls 80 and 82 are perpendicular relative to the end walls 84 and 86, and the length of the housing 52 from end wall 84 to end wall 86 is greater than the width of the housing 52 from side wall 80 to side wall 82. The opening 76 is closable by the lid 54 to close the volume 74 and its contents and openable by withdrawing the lid 54 from the opening 76 to enable access to the volume 74 and its contents. The opening 76 and the lid 54 have corresponding rectangular shapes.

The container 52 has a support 90. The support 90 supports the terminals 22, 24, 26, and 28 at the top of the container 52. The support 90 is part of the container 52. The support 90 is made of the same material as the container 52. The support 90 extends inward partly into the opening 76 from the inner surface 64 of the sidewall 82 and the end walls 84 and 86 adjacent to the rim 66. The support 90 supports the positive and negative terminals 22 and 24 and the positive and negative accessory terminals 926 and 28, the positive terminal 22 and the positive accessory terminal 26 adjacent to the end wall 84 and the negative terminal 24 and the negative accessory terminal 28 adjacent to the end wall 86. The positive terminal 22, the negative terminal 24, the positive accessory terminal 26, and the negative accessory terminal 28 extend upright from the support 90. Although the battery assembly 20 has one a pair of positive and negative accessory terminals 26 and 28, it can have multiple pairs to allow a user to connect multiple electrical accessories to the battery assembly 20.

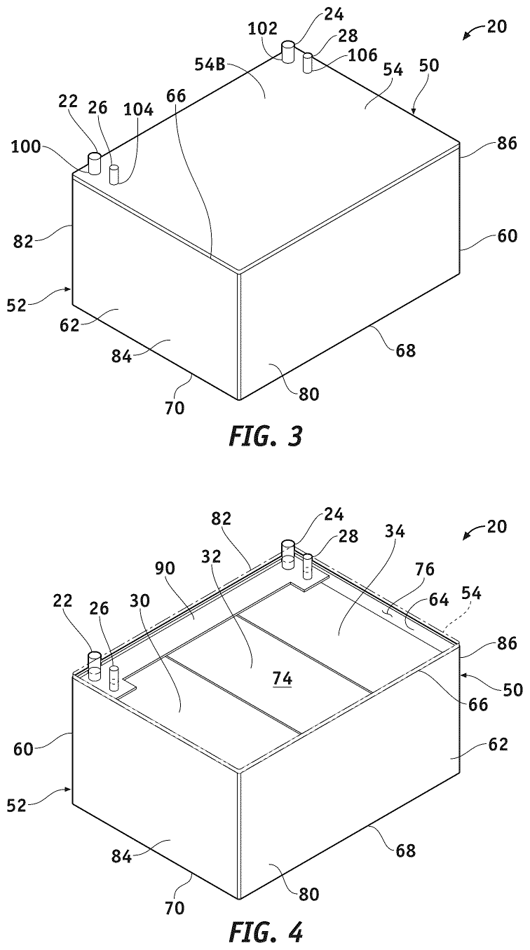

The lid 54 has cut-outs or openings 100, 102, 104, and 106 extending through the thickness of the lid 54 from the inner surface 54A to the outer surface 54B. The openings 100 and 102 are for the reception of the positive and negative terminals 22 and 24. The openings 104 and 106 are for the reception of the positive and negative accessory terminals 26 and 28. The lid 54 is movable alternately into its closed position against the rim 66 in FIG. 3, closing the opening 76 and enclosing the container's 52 volume 74 and the contents therein, and out of its closed position to an open position withdrawn from the container 52, opening the opening 76 to the container's 52 volume 74 for enabling access to the container's 52 volume 74 and its contents therein through the opening 76. The positive terminal 22, the negative terminal 24, the positive accessory terminal 26, and the negative accessory terminal 28 extend outward from the housing 50 through the openings 100, 102, 104, and 106 from the inner surface 54A to the outer surface 54B enabling access to the various terminals when the opening 76 to the container's 52 volume 74 is closed by the lid 54 in FIG. 3, enclosing the contents in the container's 52 volume 74. The lid 54 is movable alternately into and out of its closed position.

The container 52 supports the control system 40, the positive bus bar 110, and the negative bus bar 120 in the volume 74. The control system 40, the positive bus bar 110 and the negative bus bar 120 are each secured mechanically to the inner surface 64 of the container 52 according to standard methods, such as with a suitable adhesive, mechanical fasteners, etc. The control system 40 is on the inner surface 64 of the side wall 82 just below the rim 66 at an intermediate position between the ends walls 84 and 86.

The positive bus bar 110 has positive electrical contacts 112, 114, and 116. The positive bus bar 110 extends longitudinally along the inner surface 64 of the side wall 82 between the rim 66 and the bottom 70 from adjacent to the inner surface 64 of the end wall 86 to adjacent to the inner surface 64 of the end wall 84, and upright along the inner surface 64 of the side wall 82 to the positive terminal 22 and the positive accessory terminal 26. The contacts 112, 114, and 116 are spaced apart longitudinally along the positive bus bar 110 extending longitudinally along the inner surface 64 of the side wall 82 between the end walls 84 and 86. Sets of standard conductors of the positive bus bar 110 form standard electric transmission paths or pathways between the contact 112 and each of the positive terminal 22 and the positive accessory terminal 26, the contact 114 and the positive terminal 22, and the contact 116 and the positive terminal 20.

The negative bus bar 120 has negative electrical contacts 122, 124, and 126. The negative bus bar 120 extends longitudinally along the inner surface 64 of the side wall 80 between the rim 66 and the bottom 70 from adjacent to the inner surface 64 of the end wall 84 to the inner surface 64 of the end wall 86, longitudinally along the inner surface 64 of the end wall 86 between the rim 66 and the bottom 70 from the inner surface 64 of the side wall 80 to adjacent not the inner surface 64 of the side wall 82, and upright along the inner surface 64 of the end wall 86 to the negative terminal 24 and the negative accessory terminal 28. The contacts 122, 124, and 126 are spaced apart longitudinally along the positive bus bar 110 extending longitudinally along the inner surface 64 of the side wall 80 between the end walls 84 and 86. Sets of standard conductors of the negative bus bar 120 form standard electric transmission paths between the contact 122 and each of the negative terminal 24 and the negative accessory terminal 28, the contact 124 and the negative terminal 24, and the contact 126 and the negative terminal 24.

The positive bus bar 110 and the negative bus bar support their respective positive and negative electrical contacts on either side of the container 52. In this example, the positive bus bar 110 supports the contacts 112, 114, and 116 in the volume 74 at the side 82 of the container 50 and the negative bus bar 120 supports the contacts 122, 124, and 126 at the side 80 of the container 50. The positive and negative electrical contacts 112 and 122 are aligned axially and are for the electrically connecting to the respective positive and negative electrical contacts 30A and 30B of the power module 30. The positive and negative electrical contacts 114 and 124 are aligned axially and are for the electrically connecting to the respective positive and negative electrical contacts 32A and 32B of the power module 32. The positive and negative electrical contacts 116 and 126 are aligned axially and are for the electrically connecting to the respective positive and negative electrical contacts 34A and 34B of the power module 34.

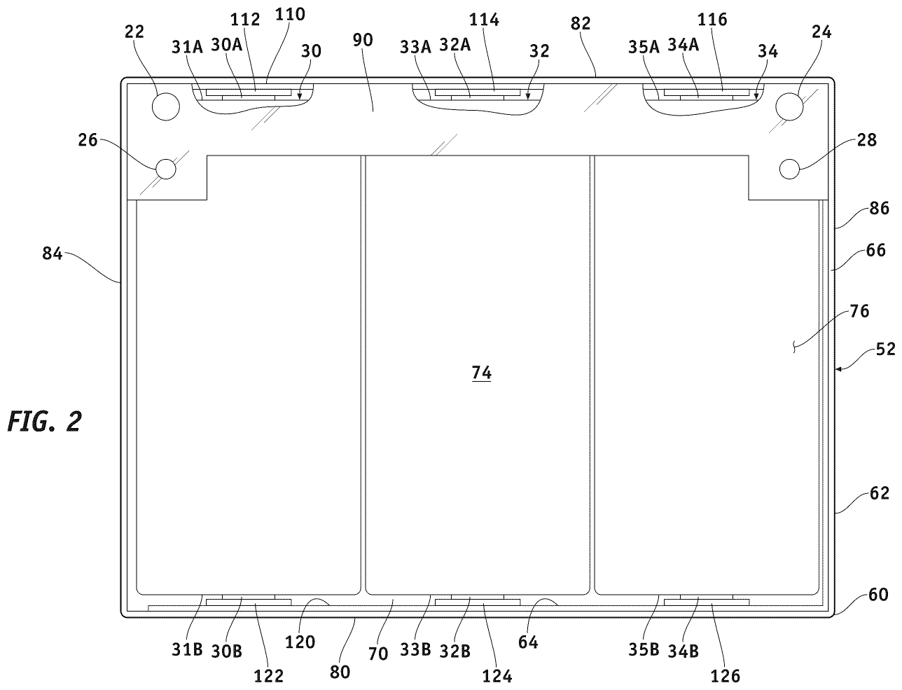

The container's 52 volume 74 receives the power modules 30, 32, and 34 through the opening 76 in FIGS. 2 and 4 before being closed by the lid 72 in FIG. 3, enclosing the power modules 30, 32, and 34 in the housing 50. The power modules 30, 32, and 34 installed in the volume 74 are closely side-by-side and connect electrically to the contacts of the positive and negative bus bars 110 and 120, shown in FIG. 2.

In FIG. 2, the power module 30 extends across the volume 74 from the end 31B and its contact 30B in direct contact against contact 122 to under the support 90 and to the end 31A and its contact 30A in direct contact against contact 112, electrically connecting the power module 30 to the negative and positive bus bars 120 and 110, electrically connecting the power module 30 to the negative terminal 24, the positive terminal 22, the negative accessory terminal 28, and the positive accessory terminal 26 through the positive bus bar 110 and the negative bus bar 120. The power module 30 powers the control system 40 and supplies power through positive and negative terminals 22 and 24 and the positive and negative accessory terminals 26 and 28 when the power module 30 is electrically connected to the positive bus bar 110 and the negative bus bar 120.

The power module 32 extends across the volume 74 from the end 33B and its contact 32B in direct contact against contact 124 to under the support 90 and to the end 33A and its contact 32A in direct contact against contact 114, electrically connecting the power module 32 to the negative and positive bars 120 and 110, electrically connecting the power module 32 to the negative terminal 24 and the positive terminal 22 through the negative bus bar 120 and the positive bus bar 110. The power module 32 supplies its surplus power through positive and negative terminals 22 and 24 when the power module 32 is electrically connected to the positive bus bar 110 and the negative bus bar 120.

The power module 34 extends across the volume 74 from the end 35B and its contact 34B in direct contact against contact 126 to under the support 90 and to the end 35A and its contact 34A in direct contact against contact 116, electrically connecting the power module 34 to the negative and positive bars 120 and 110, electrically connecting the power module 34 to the negative terminal 24 and the positive terminal 22 through the negative bus bar 120 and the positive bus bar 110 through the switch 46, in which the open position of the switch 46 disconnects the power module 34 from the positive terminal 22 and the negative terminal 24 and the closed position of the switch 46 electrically connects the power module 34 to the positive terminal 22 and the negative terminal 24, enabling the power module 34 to supply its power through the positive terminal 22 and the negative terminal 24.

After installing the power modules 30, 32, and 34 into the container's 52 volume 74 through the opening 76, closing the container 52 by the lid 54 in FIG. 3 closes the opening 76 and encloses the container's 52 volume 74 and the contents therein so the positive terminal 22, the negative terminal 24, the positive accessory terminal 26 and the negative accessory terminal 28 extend outward from the housing 50 through the openings 100, 102, 104 and 106, enabling access to the various terminals for connecting them to their respective circuits. FIG. 4 is a view corresponding to FIG. 3, the lid 54 depicted in phantom outline for illustrative purposes, illustrating the contents in the container's 52 volume 74. Moving the lid 54 out of its closed position to its open position withdraws the lid 54 from the container 52, enabling access to the volume 74 and its contents through the opening 76.

In the assembled battery assembly 20, the power modules 30, 32 and 34 work with the various terminals as described above. The PMM 44 can work in multiple modes of operation. In one embodiment, the PMM module 44 is programmed to monitor the power module 30 and issue the signal to the controller 42 when the power module 30 is low or significantly discharged. In another embodiment, the PMM module 44 is programmed to monitor the power module 30 and the power module 32 and issue the signal to the controller 42 when the power module 30 and the power module 32 are low or significantly discharged. In each embodiment, the controller 42 is programmed to turn the switch 46 from its normal open position automatically, disconnecting the power module 34 from each of the positive terminal 22 and the negative terminal 24, to the closed position, connecting the power module 34 to the positive terminal 22 and the negative terminal 24 through the closed switch 46 when the processor 42 receives the signal. When the switch 46 is in its closed position, the power module 34 provides booster- or jump-start power through the positive terminal 22 and the negative terminal 24 and a current through the circuit of the motor vehicle connected to the positive and negative terminals 22 and 24 during motor vehicle start to actuate the starter motor to jump-start the engine. This prevents the driver of the motor vehicle from being stranded and allows him to drive his vehicle home or to the nearest service center for servicing or replacing one or more of the power modules 30, 32, and 34. The power module 34 can be configured to effectuate a single emergency start or multiple start cycles.

In FIG. 5, the IoT module 48 enables receipt by and user access to the PMM module 44 information via a standard user interface 146 of a device 148 networked or otherwise operatively connected to the IoT module 48, such as a user interface of the vehicle, a computer, a smartphone, a tablet computer, or other computing device, which can be configured with dedicated application software to facilitate interaction with the control system 40 via the IoT module 48. The PMM module's 44 information functions to inform a user of operational parameters of the power modules 30, 32, and 34, enabling the user to effectuate needed power module servicing or replacement. The controller 42 can be programmed to issue power module 30, power module 32, and power module 34 warning messages via the IoT module 144, such as when their respective performance characteristics monitored by the PMM module 44 fall to or below pre-defined thresholds. The controller 42 can also be programmed to issue notifications about the battery assembly's 20 ongoing operations, including power levels and capacities and recharging capacities of the various modules 30, 32, and 34 as monitored by the PMM module 44.

The lid 54 is movable alternately into and out of its closed position relative to the container 52. When the container 52 is opened by withdrawing the lid 54 from the container 52, a user may conveniently access the container's 52 volume 74 and the modules 30, 32, and 34 therein as needed for repair, refurbishment, and or replacement as needed. The self-contained modules 30, 32, and 34 are independent of one another, allowing their selective and independent installation into the container's 52 volume 74 through the opening 76, withdrawal from the container's 52 volume 74 through opening 76, and refurbishment or replacement. If desired, the control system 40 can be configured with a GPS module to allow location tracking of the battery assembly 20 and to allow the controller 42 to automatically determine and issue a corresponding notification to a user via the IoT module 48 of the nearest participating service center able to service the battery assembly 20 when the controller 42 closes the switch 46, connecting the power module 34 to the positive terminal 22 and the negative terminal 24.

The battery assembly 20 replaces a standard vehicle battery. It has three power modules 30, 32 and 34, each configured to perform their applicable functions as described herein. Depending on specific applications, their numbers and the corresponding components of the battery assembly 20 can be multiplied in alternate embodiments. For example, the power module 30 can consist of two or more batteries or battery modules, the power module 32 can consist of two or more supercapacitors or supercapacitor modules, and the power module 34 can consist of two or more booster batteries or booster battery modules. The number of each power module can be the same or different. Any practical number and combinations of power modules can be used in alternate embodiments. A battery assembly constructed and arranged according to the invention may have one or more power modules 30 in combination with one or more power modules 32 without one or more power modules 34. In other embodiments, a battery assembly constructed and arranged according to the invention may have one or more power modules 30 in combination with one or more power modules 34 without providing one or more power modules 32.

### II.

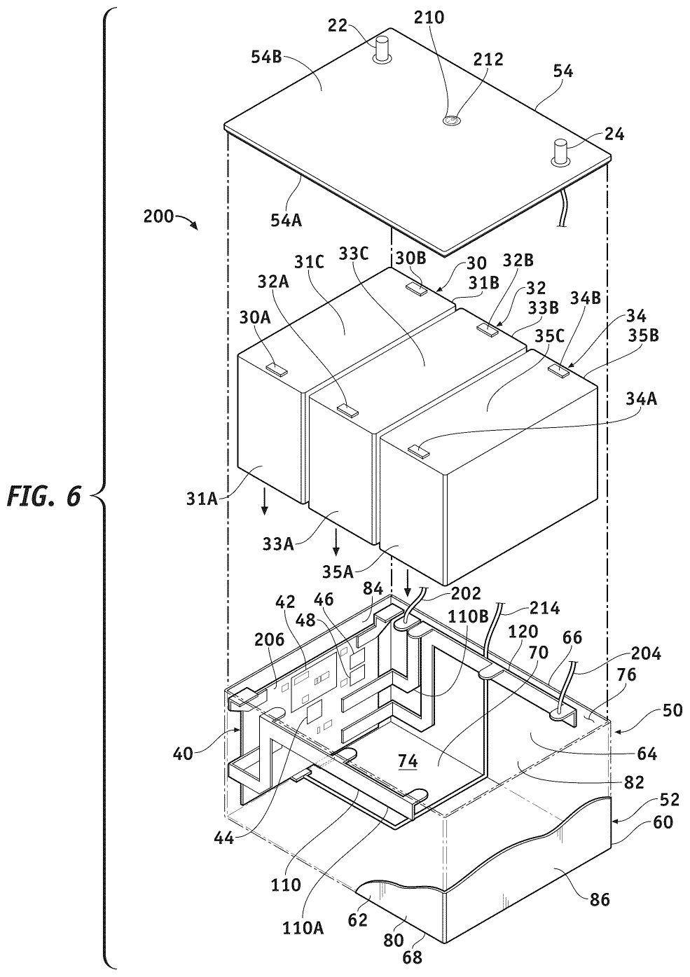

Shown in FIGS. 6-14 is an alternate embodiment of a battery assembly 200. Referring to FIGS. 6-8, 11, and 12 relevantly, in common with battery assembly 20 the battery assembly 200 shares positive terminal 22, negative terminal 24, power modules 30, 32, and 34, control system 40, positive bus bar 110, negative bus bar 120 and housing 50 therefor. Accordingly, the common components of the battery assemblies 20 and 200 have the same reference characters and how the common components work and their structural and functional relationships in the battery assembly 200 are identical to the battery assembly 20 discussed in detail above. Accordingly, the battery assemblies 20 and 200 are essentially the same and the disclosure of battery assembly 20 applies in every respect to battery assembly 200, except for certain differences discussed in detail below.

The positive terminal 22, the negative terminal 24, and a switch 210 are carried by the housing's 50 lid 54. The positive terminal 22 and the negative terminal 120 are wired to the positive bus bar 110 and the negative bus bar 120, respectively, with suitable wires 202 and 204. The positive terminal 22 and the negative terminal 24 extend through the thickness of the lid 54 from the inner surface 54A to the outer surface 54B and beyond the outer surface 54B to connect to the circuit of the motor vehicle. The wire 202 is electrically connected between the positive bus bar 110 and the positive terminal 22 at the lid's 54 inner surface 54A. The wire 204 is electrically connected between the negative bus bar 120 and the negative terminal 24 at the lid's 54 inner surface 54A. The wires 202 and 204 wire the positive and negative bus bars 110 and 120 to the positive terminal 22 and the negative terminal 24, respectively.

The positions of the positive and negative contacts of the various power modules are different in the battery assembly 200. In FIG. 6, the power module's 30 positive and negative contacts 30A and 30B are at the top 31C of the power module 30 adjacent to the opposite ends 31A and 31B, respectively. The power module's 32 positive and negative contacts 32A and 32B are at the top 33C of the power module 32 adjacent to the opposite ends 33A and 33B. Finally, the power module's 34 positive and negative contacts 34A and 34B are at the top 35C of the power module 34 adjacent to the opposite ends 35A and 35B.

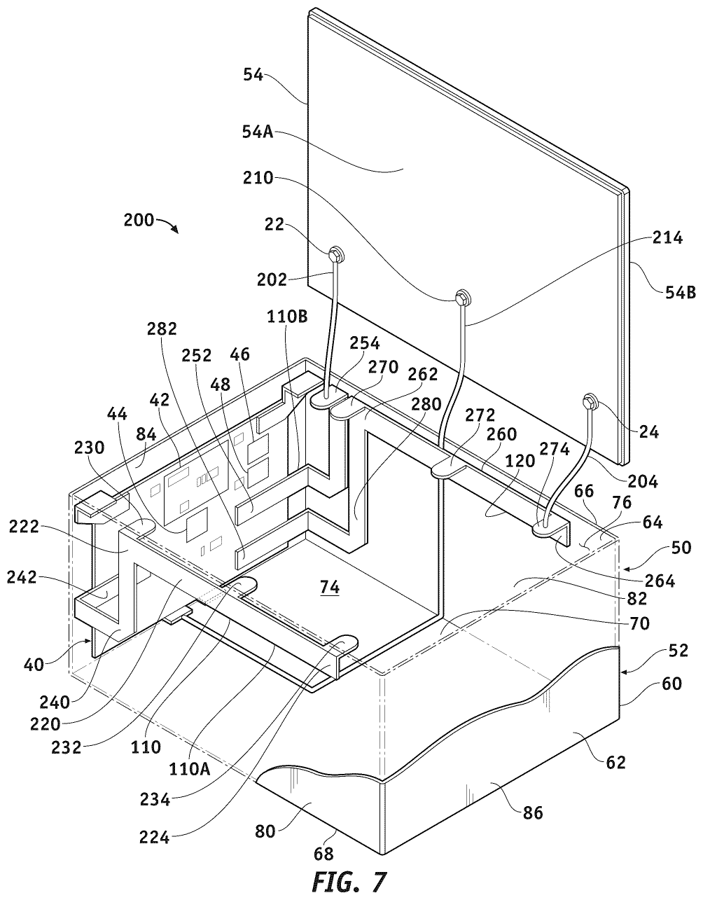

In FIGS. 6 and 7, the control system 40 is a standard printed circuit board 206 that mechanically supports and electrically and signally connects the controller 42, the PMM module 44, the switch 46, and the IoT module 48. The positive bus bar 110 and the negative bus bar 120 electrically connect through the control system 40 to positive terminal 22 and the negative terminal 24 by the respective wires 202 and 204. The board's 202 components are usually soldered onto the board 206, providing a stable base that allows for the routing of electrical signals between them.

In FIG. 6, the switch 210 is a standard toggle switch manually actuated by its mechanical rocking mechanism 212. The switch 210 extends through the thickness of the lid 54 from the inner surface 54A in FIG. 7 to the mechanical rocking mechanism 208 at the outer surface 54B in FIG. 6, allowing it to be actuated manually by hand from exteriorly of the outer surface 54B. The switch 210 is wired to the board 206 with a suitable wire 214. The positive bus bar 110 and the negative bus bar 120 are connected electrically through the board 206 to the wire 214 electrically connected to the switch 210. The wire 214 is electrically connected between the board 206 and the switch 210 at the lid's 54 inner surface 54A. The wire 214 wires the board 206 to the switch 210, connecting the positive and negative terminals 22 and 24 to the switch 210 through the positive and negative bus bars 110 and 120. The wire 214 extends along the inner surface of bottom 70 from the board 206 to the inner surface 64 of the side wall 82, upward along the inner surface 64 of the side wall 82 to the rim 66 and beyond the rim 66 to the switch 210.

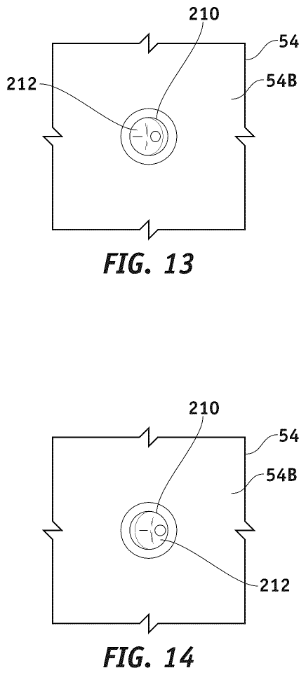

The power module 34 connects electrically to the positive bus bar 110 and the negative bus bar 120 that connect the power module 34 electrically through the switch 210 to the positive terminal 22 and the negative terminal 24 when the power module 34 is electrically connected to the positive bus bar 110 and the negative bus bar 120. The switch 210 works between the power module 34 and the positive terminal 22 and the negative terminal 24 when the power module 34 is electrically connected to the positive bus bar 110 and the negative bus bar 120. The switch 210 has an open position in FIG. 13, disconnecting the power module 34 from the positive terminal 22 and the negative terminal 24 when the power module 34 is electrically connected to the positive bus bar 110 and the negative bus bar 120, and a closed position in FIG. 14, connecting the power module 34 through the positive bus bar 110 and the negative bus bar 120 to the positive terminal 22 and the negative terminal 24 when the power module 34 is electrically connected to the positive bus bar 110 and the negative bus bar 120. The power module 34 electrically connects to the positive bus bar 110 and the negative bus bar 120 electrically connected to the positive terminal 22 and the negative terminal 24, respectively, through the switch 210. The switches 46 and 210 work independently from one another. The expedient of the switch 210 allows an operator to use the switch 210 to manually connect and disconnect the power module 34 to and from the positive terminal 22 and the negative terminal 24 as desired.

Referring to FIGS. 6-8 relevantly, the container 52 supports the control system 40, the positive bus bar 110, and the negative bus bar 120 in the volume 74, each of which is secured mechanically to the inner surface 64 of the container 52 according to standard methods, such as with a suitable adhesive, mechanical fasteners, etc. The board 206 is on the inner surface 64 of the end wall 84 and extends upright from adjacent to the bottom 70 to just below the rim 66 and across the inner surface of the end wall 84 from adjacent to the side wall 80 to adjacent to the side wall 82.

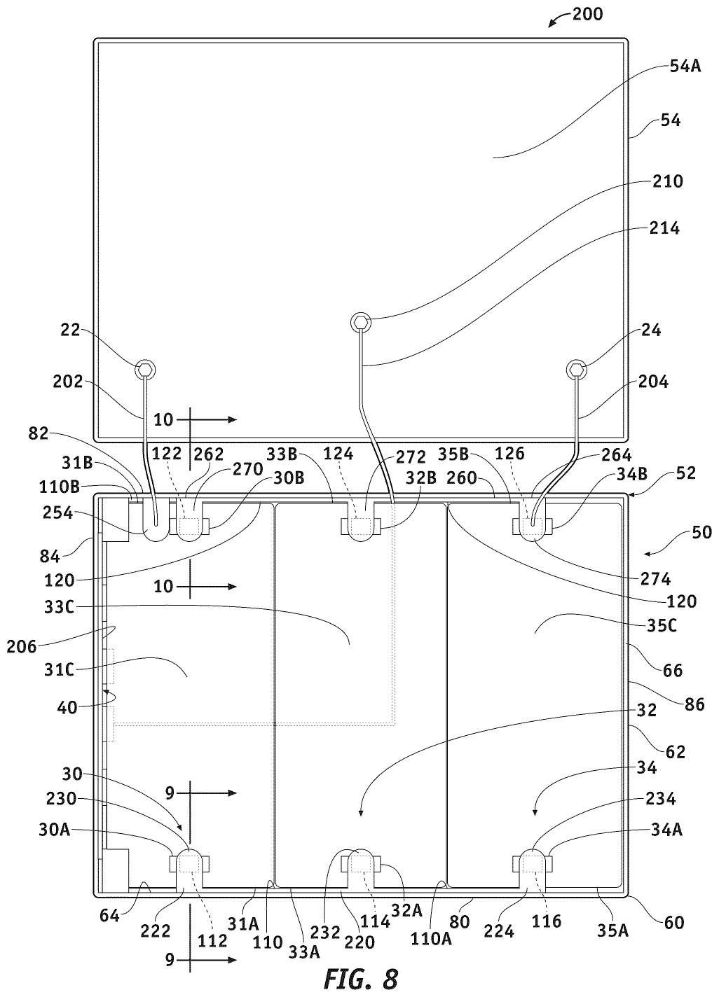

Referring to FIGS. 7 and 8 relevantly, the positive bus bar 110 has two components 110A and 120B having respective connecting ends 242 and 252 connected to the board 206. The components 110A and 110B work as the bus bar 110. Component 110A supports the contacts 112, 114, and 116, shown in dotted outline in FIG. 8. The component 110A has a longitudinal part 220 and a connecting part 240. The longitudinal part 220 has opposed ends 222 and 224. The longitudinal part 220 extends along the inner surface 64 of the side wall 80 adjacent to the rim 66 and the opening 76 from its end 222 adjacent to the inner surface 64 of the end wall 84 to its end 224 adjacent to the inner surface 64 of the end wall 86. The longitudinal part 220 has tabs 230, 232, and 234 that support the respective contacts 112, 114, and 116 in the volume 74 adjacent to the rim 66 and the opening 76. The tabs 230, 232, and 234 are spaced apart longitudinally along the length of the longitudinal part 220 between the ends 222 and 224 and extend inwardly into the opening 76, supporting the respective contacts 112, 114, and 116 over the bottom 70. The tab 232 and its contact 114 are between the tab 230 and its contact 112 adjacent to the end 222 and the tab 234 and its contact 116 adjacent to the end 224. The connecting part 240 extends downward from the end 222, across the inner surface 64 of the side wall 80 toward the inner surface 64 of the end wall 84 and inwardly across the inner surface 64 of the end wall 84 from the inner surface 64 of the side wall 80 to its connecting end 242 mechanically and electrically connected to the board 206. The component 110B extends outward to the inner surface 64 of the side wall 82 from its connecting end 252 mechanically and electrically connected to the board 206, and upwardly across the inner surface 64 of the side wall 82 to a tab 254 adjacent to the rim 66. The wire 202 is electrically connected between the tab 254 of the positive bus bar's 110 component 110B and the positive terminal 22 at the lid's 54 inner surface 54A.

The negative bus bar 120 supports the contacts 122, 124, and 126, shown in dotted outline in FIG. 8, and has a connecting end 282 connected to the board 206. The negative bus bar 120 has a longitudinal part 260 and a connecting part 280. The longitudinal part 260 has opposed ends 262 and 264. The longitudinal part 260 extends along the inner surface 64 of the side wall 82 adjacent to the rim 66 and the opening 76 from its end 262 adjacent to the inner surface 64 of the end wall 84 to its end 264 adjacent to the inner surface 64 of the end wall 86. The longitudinal part 260 has tabs 270, 272, and 274 that support the respective contacts 122, 124, and 126 in the volume 74 adjacent to the rim 66 and the opening 76. The tabs 270, 272, and 274 are spaced apart longitudinally along the length of the longitudinal part 260 between the ends 262 and 264 and extend inwardly into the opening 76, supporting the respective contacts 122, 124, and 126 in over the bottom 70. The tab 272 and its contact 124 are between the tab 270 and its contact 122 adjacent to the end 262 and the tab 274 and its contact 126 adjacent to the end 224. The tabs 230, 232, and 234 and the contacts they carry at one side of the container 52 are aligned axially with the respective tabs 270, 272, and 274 and the contacts they carry at the opposite side of the container 52. The connecting part 280 extends downward from the end 262, across the inner surface 64 of the side wall 82 toward the inner surface 64 of the end wall 84 and inwardly across the inner surface 64 of the end wall 84 from the inner surface 64 of the side wall 80 to its connecting end 282 mechanically and electrically connected to the board 206. The wire 204 is electrically connected between the tab 274 and the negative terminal 24 at the lid's 54 inner surface 54A.

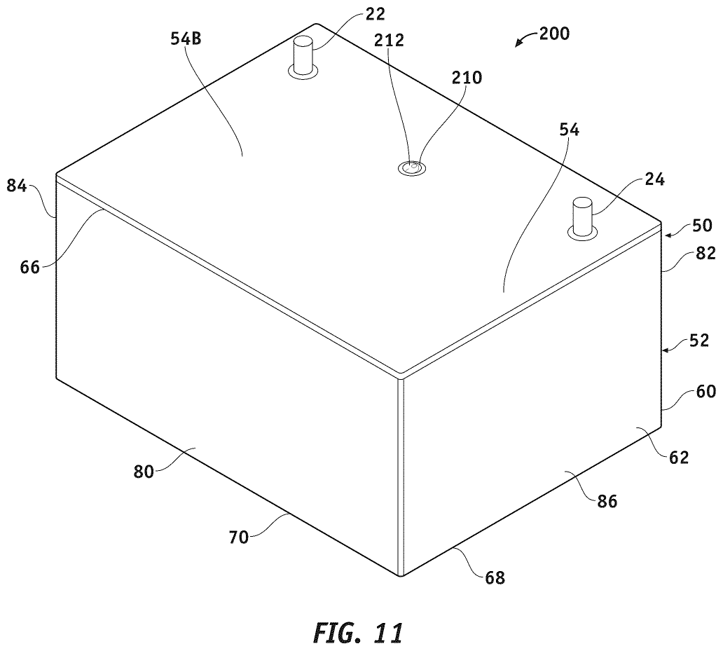

The container's 52 volume 74 receives the power modules 30, 32, and 34 through the opening 76 in FIGS. 6 and 8 before being closed by the lid 72 in FIG. 11, enclosing the power modules 30, 32, and 34 in the housing 50. The power modules 30, 32, and 34 installed in the volume 74 are closely side-by-side and connect electrically to the contacts of the positive and negative bus bars 110 and 120.

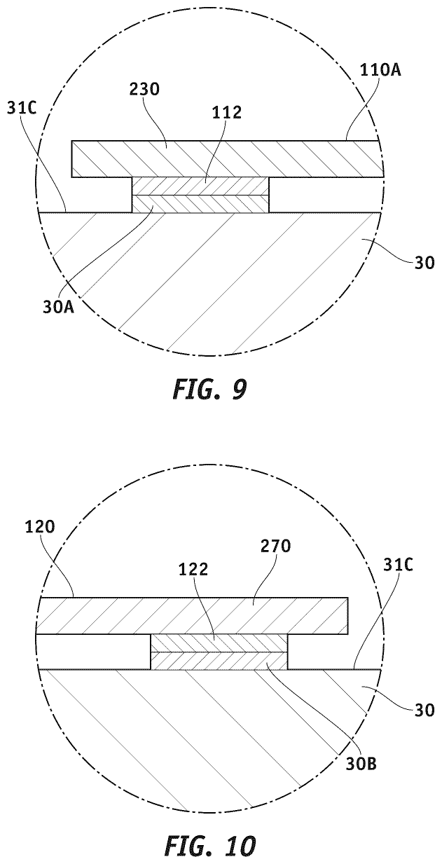

In FIG. 8, the power module 30 extends upright to the top 31C and its contacts 30A and 30B and across the volume 74 from its contact 30A under and in direct contact against the overlying contact 112 in FIG. 9 to its contact 30B under and in direct contact against the overlying contact 122 in FIG. 10, electrically connecting the power module 30 to the positive and negative bus bars 110 and 120, electrically connecting the power module 30 to the positive terminal 22 and the negative terminal 24 through the positive bus bar 110 and the negative bus bar 120. The power module 30 powers the control system 40 and supplies power through positive and negative terminals 22 and 24 when the power module 30 is electrically connected to the positive bus bar 110 and the negative bus bar 120.

The power module 32 extends upright to the top 33C and its contacts 32A and 32B and across the volume 74 from its contact 32A under and in direct contact against the overlying contact 114 to its contact 32B under and in direct contact against the overlying contact 124, electrically connecting the power module 32 to the positive and negative bus bars 110 and 120, electrically connecting the power module 32 to the positive terminal 22 and the negative terminal 24 through the positive bus bar 110 and the negative bus bar 120. The contacts 32A and 32B contact their contacts 114 and 124 in the same way contacts 30A and 30B contact their contacts 112 and 122. The power module 32 supplies its surplus power through positive and negative terminals 22 and 24 when the power module 32 is electrically connected to the positive bus bar 110 and the negative bus bar 120.

The power module 34 extends upright to the top 35C and its contacts 34A and 34B and across the volume 74 from its contact 34A under and in direct contact against the overlying contact 116 to its contact 34B under and in direct contact against the overlying contact 126, electrically connecting the power module 34 to the negative terminal 22 and the positive terminal 24 through the positive bus bar 110 and the negative bus bar 120 through the switch 46 and through the switch 210. The contacts 34A and 34B contact their contacts 116 and 126 in the same way contacts 30A and 30B contact their contacts 112 and 122 and contacts 32A and 32B contact their contacts 114 and 124. The open position of the switch 46 disconnects the power module 34 from the positive terminal 22 and the negative terminal 24 and the closed position of the switch 46 electrically connects the power module 34 to the positive terminal 22 and the negative terminal 24, enabling the power module 34 to supply its power through the positive terminal 22 and the negative terminal 24. The open position of the switch 210 disconnects the power module 34 from the positive terminal 22 and the negative terminal 24 and the closed position of the switch 210 electrically connects the power module 34 to the positive terminal 22 and the negative terminal 24, enabling the power module 34 to supply its power through the positive terminal 22 and the negative terminal 24 through selective manual operation of the switch 210 independently of the switch 46.

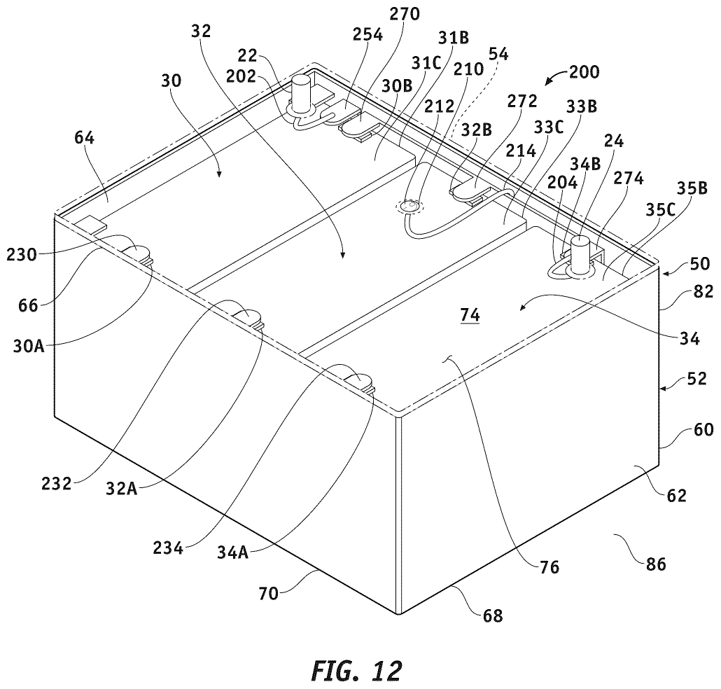

After installing the power modules 30, 32, and 34 into the container's 52 volume 74 through the opening 76, closing the container 52 by the lid 54 in FIG. 11 closes the opening 76 and encloses the container's 52 volume 74 and the contents therein so the positive terminal 22 and the negative terminal 24 extend outward from the outer surface 54B of the lid 54 of the housing 50, enabling access to the positive terminal 22 and the negative terminal 24. The rocking mechanism 212 exposed at the outer surface 54B of the lid 54 allows a user to selectively access and actuate it from outside the housing 50. FIG. 12 is a view corresponding to FIG. 11, the lid 54 depicted in phantom outline for illustrative purposes, illustrating the contents in the container's 52 volume 74. Moving the lid 54 out of its closed position to its open position withdraws the lid 54 from the container 52, enabling access to the volume 74 and its contents through the opening 76 as discussed above with the battery assembly 20.

The switch 210 extends through the thickness of the lid 54 from the inner surface 54A in FIG. 7 to the mechanical rocking mechanism 208 at the outer surface 54B in FIG. 6, allowing it to be actuated manually by hand from exteriorly of the outer surface 54B. If desired, the switch 210 can be carried by the container 52 so it extends through the thickness of the sidewall 60 from the inner surface 64 to the mechanical rocking mechanism 208 at the outer surface 62, allowing it to be actuated manually by hand from exteriorly of the outer surface 62. Although the battery assembly 200 is without accessory terminals, it can have one or more pairs of them powered by the power module 30 like the battery assembly 20.

### III.

The present invention is described above with reference to illustrative embodiments. Those skilled in the art will recognize that changes and modifications may be made in the described embodiments without departing from the scope of the present invention. Various changes and modifications to the embodiments herein chosen for purposes of illustration will readily occur to those skilled in the art. To the extent that such modifications and variations do not depart from the invention, they are intended to be included within the scope thereof.

Having fully described the invention in such clear and concise terms as to enable those skilled in the art to understand and practice the same, the invention claimed is:

1. An automotive battery assembly, comprising:
a control system including a switch having an open position and a closed position;
an automotive battery connected to a positive terminal and a negative terminal;
a booster battery connected to the positive terminal and the negative terminal through the switch in the open position, disconnecting the booster battery from the positive terminal and the negative terminal; and
the control system to monitor the automotive battery and turn the switch from the open position to the closed position automatically when the automotive battery is low or significantly discharged, connecting the booster battery to the positive terminal and the negative terminal to provide a burst of power through the positive terminal and the negative terminal.

2. The automotive battery assembly according to claim 1, wherein the automotive battery and the booster battery are separately replaceable.

3. The automotive battery assembly according to claim 1, wherein the automotive battery is connected to the positive terminal and the negative terminal through a positive bus bar and a negative bus bar, respectively.

4. The automotive battery assembly according to claim 1, wherein the booster battery is connected to a positive bus bar and a negative bus bar, respectively, connected to the positive terminal and the negative terminal, respectively, through the switch.

5. The automotive battery assembly according to claim 1, wherein the control system, the automotive battery, the positive terminal, the negative terminal and the booster battery are held by a housing, the positive terminal and the negative terminal extending outward from the housing.

6. An automotive battery assembly, comprising:
a control system including a switch having an open position and a closed position;
an automotive battery and a supercapacitor each connected to a positive terminal and a negative terminal;
a booster battery connected to the positive terminal and the negative terminal through the switch in the open position, disconnecting the booster battery from the positive terminal and the negative terminal; and
the control system to monitor the automotive battery and the supercapacitor and turn the switch from the open position to the closed position automatically when the automotive battery and the supercapacitor are low or significantly discharged, connecting the booster battery to the positive terminal and the negative terminal to provide a burst of power through the positive terminal and the negative terminal.

7. The automotive battery assembly according to claim 6, wherein the automotive battery, the supercapacitor and the booster battery are separately replaceable.

8. The automotive battery assembly according to claim 6, wherein the automotive battery and the supercapacitor are connected to the positive terminal and the negative terminal through a positive bus bar and a negative bus bar, respectively.

9. The automotive battery assembly according to claim 6, wherein the booster battery is connected to a positive bus bar and a negative bus bar, respectively, connected to the positive terminal and the negative terminal, respectively, through the switch.

10. The automotive battery assembly according to claim 6, wherein the control system, the automotive battery, the supercapacitor, the positive terminal, the negative terminal and the booster battery are held by a housing, the positive terminal and the negative terminal extending outward from the housing.

11. An automotive battery assembly, comprising:
an automotive battery connected to a positive terminal and a negative terminal; and
a booster battery connected to the positive terminal and the negative terminal through a toggle switch having an open position, disconnecting the booster battery from the positive terminal and the negative terminal, and a closed position, connecting the booster battery to the positive terminal and the negative terminal to provide a burst of power through the positive terminal and the negative terminal.

12. The automotive battery assembly according to claim 11, wherein the automotive battery and the booster battery are separately replaceable.

13. The automotive battery assembly according to claim 11, wherein the automotive battery is connected to the positive terminal and the negative terminal through a positive bus bar and a negative bus bar, respectively.

14. The automotive battery assembly according to claim 11, wherein the booster battery is connected to a positive bus bar and a negative bus bar, respectively, connected to the positive terminal and the negative terminal, respectively, through the switch.

15. The automotive battery assembly according to claim 11, wherein the automotive battery, the positive terminal, the negative terminal, the booster battery and the toggle switch are held by a housing, the positive terminal and the negative terminal extending outward from the housing and the toggle switch accessible from outside the housing.

16. An automotive battery assembly, comprising:
an automotive battery and a supercapacitor each connected to a positive terminal and a negative terminal; and
a booster battery connected to the positive terminal and the negative terminal through a toggle switch having an open position, disconnecting the booster battery from the positive terminal and the negative terminal, and a closed position, connecting the booster battery to the positive terminal and the negative terminal to provide a burst of power through the positive terminal and the negative terminal.

17. The automotive battery assembly according to claim 16, wherein the automotive battery, the supercapacitor and the booster battery are separately replaceable.

18. The automotive battery assembly according to claim 16, wherein the automotive battery and the supercapacitor are connected to the positive terminal and the negative terminal through a positive bus bar and a negative bus bar, respectively.

19. The automotive battery assembly according to claim 16, wherein the booster battery is connected to a positive bus bar and a negative bus bar, respectively, connected to the positive terminal and the negative terminal, respectively, through the switch.

20. The automotive battery assembly according to claim 16, wherein the automotive battery, the supercapacitor, the positive terminal, the negative terminal, the booster battery and the toggle switch are held by a housing, the positive terminal and the negative terminal extending outward from the housing and the toggle switch accessible from outside the housing.
